(19) United States
(12) Patent Application Publication
(10) Pub. No.: US 2008/0204249 A1
(43) Pub. Date: Aug. 28, 2008

(54) Radio frequency identification systems for electronic devices

(76) Inventors: Kai-Cheng Chang, Taipei City (TW); Ya-Ping Chen, Kaohsiung County (TW); Bo-Chen Wu, Hsinchu City (TW); Yung-Chin Lo, Taipei County (TW)

Correspondence Address: Akin Gump LLP - Silicon Valley, 3000 El Camino Real, Two Palo Alto Square, Suite 400, Palo Alto, CA, 94306, US

(21) Appl. No.: 11/711,342

(22) Filed: Feb. 26, 2007

(51) Int. Cl. G08B 13/14

(52) U.S. Cl. 340/572.7

(57) ABSTRACT

A system comprises an electronic device for providing a particular electronic function, an radio frequency identification (RFID) tag connecting to an antenna, and an interface for connecting the primary module and the RFID tag. The RFID tag is capable of having wireless communicating through the antenna. The electronic device and the RFID tag are capable of communicating with each other through the interface.

### BACKGROUND OF THE INVENTION

1. Field of the Invention

This invention generally relates to radio frequency identification (RFID) systems and, more particularly, to RFID systems for electronic devices.

2. Background of the Invention

Wireless communications are becoming more and more pervasive in our modem lives. Among emerging wireless communication technologies, RFID is one wireless identification and tracking technology that may be applied for various applications, such as inventory management, personnel identification, and automotive toll debiting. The use of RFID systems may allow devices with RFID tags to provide information to a system without complicated process or circuitry.

As an example of their applications, RFID systems are popular in identification and tracking applications because RFID tags may be very small, light, and inexpensive. In addition, passive RFID tags receive power from the signals provided by interrogators, and thus, require no internal power supply. Further, RFID systems may offer customized solutions for various applications and provide relatively high speed data transfer between tags and interrogators.

Manufacturers and users of electronic devices may have a need for access to information about the devices in order to verify manufacturing data (i.e., time of assembly), parts information, and servicing data (e.g., time of sale, date of last service, date when next service is due) for inventory or repair purposes. In general, such information may be tracked by placing serial numbers on electronic devices and storing these serial numbers along with the corresponding product information in a large centralized database. That may result in requiring a large size of a database to store product serial numbers and related information. In addition, the database does not necessarily contain updated or most-recent information about the devices.

### BRIEF SUMMARY OF THE INVENTION

One example consistent with the invention provides a system which comprises an electronic device for providing a particular electronic function, a radio frequency identification (RFID) tag connecting to an antenna, and an interface for connecting the primary module and the RFID tag. The RFID tag is capable of having wireless communicating through the antenna. The electronic device and the RFID tag are capable of communicating with each other through the interface.

Another example consistent with the invention provides a method of operating a tracking system. The steps comprise providing a requesting signal to request communication with an electronic device, transmitting data from the electronic device to the interface, converting the data from the electronic device into radio frequency identification (RFID) signals, and transmitting the RFID signals from the interface to an RFID tag.

In another example, the invention provides an interface for providing communication between an electronic device and an RFID tag which comprising an microcontroller which provides control of communication between the electronic device and an RFID tag, and an interface circuit for converting data from the electronic device into a RFID signal.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The foregoing summary, as well as the following detailed description of the invention, will be better understood when read in conjunction with the appended, exemplary drawings. It should be understood, however, that the invention is not limited to the precise arrangements and instrumentalities shown.

In the drawings:

FIG. 1 illustrates an exemplary communication system in examples consistent with the present invention;

FIG. 2 is a simplified block diagram of an exemplary electronic device 100 in examples consistent with the present invention;

FIG. 3 illustrates an exemplary RFID interrogator in examples consistent with the present invention;

FIG. 4 illustrates an exemplary RFID tag in examples consistent with the present invention;

FIG. 5 illustrates an exemplary interface in examples consistent with the present invention;

FIG. 6 illustrates portions of the communication system of FIG. 1;

FIG. 7 is a flow chart of communication between an RFID tag and an electronic device in examples consistent with the present invention; and

FIG. 8 is a flow chart of communication between an RFID tag and an electronic device in examples consistent with the present invention.

### DETAILED DESCRIPTION OF THE INVENTION

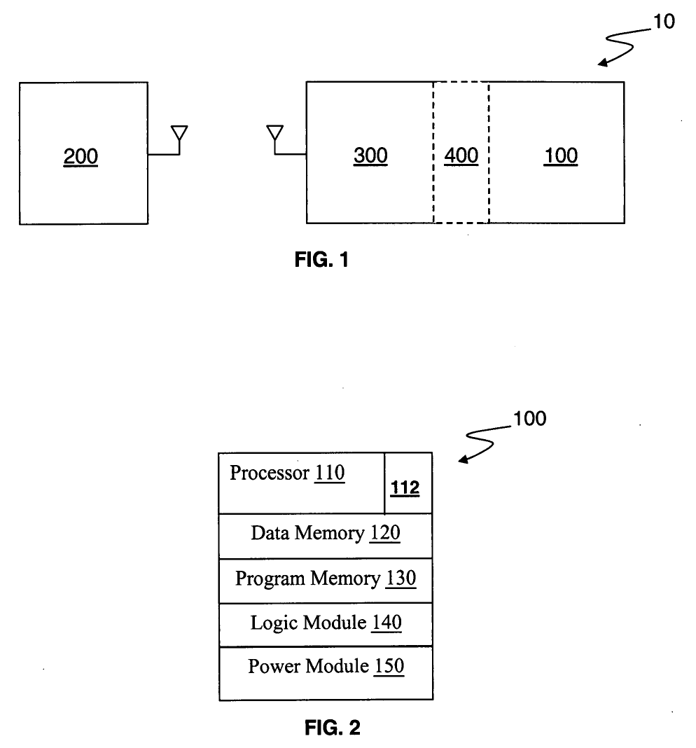

FIG. 1 illustrates an exemplary communication system 10 in examples consistent with the present invention. Referring to FIG. 1, the system 10 may include an electronic device 100, a radio frequency identification (RFID) system comprising an RFID interrogator 200 and an RFID tag 300, and an interface 400 connecting between the RFID tag 300 and the electronic device 100.

The electronic device 100 may be any devices used in daily life. Examples of the electronic device 100 may include PDAs (personal digital assistants), cellular phones, digital refrigerators, digital air conditioning systems, digital dehumidifiers, digital network connectors, digital televisions, digital communication systems, digital security systems, vehicle computer systems, calculators, digital home appliances, and digital surveillance systems. In some examples, the RFID tag 300 and other RFID tags may locate remotely or at a distance from the RFID interrogator 200 and each coupled to a device to be monitored. The RFID interrogator 200 may recover information stored in the RFID tag 300 by sending an interrogating signal to query the RFID tag 300. In response, the RFID tag 300 may transmit a responding signal, which may contain information in an encoded format, back to the RFID interrogator 200.

FIG. 2 shows a simplified block diagram of an exemplary electronic device 100 in examples consistent with the present invention. The electronic device 100 may include a processor 110, a data memory 120, a program memory 130, a logic unit 140 and a power source 150. The electronic device 100 may also include a memory 112 for storing important or real-time data regarding, for example, the operation of the electronic device 100. The data in the memory 112 may include a basic input-output system (BIOS), operation parameters such as temperature, moisture and pressure, and electrical parameters such as voltage and current levels, depending on the functions of the electronic device 100. Referring to FIG. 2, the electronic device 100 may be configured to perform a particular electronic function, and the processor 110 and the program memory 130 within the electronic device 160 are adapted for the particular electronic function. Thus, if the electronic device 100 is a cellular phone, the program memory 130 may store the necessary programs for operation of the cellular phone and the data memory 120 may store relevant phone data, such as an automatic dialing directory or identification of phone numbers which placed an unanswered call to the cellular phone. In one example, the electronic device 100 may include a personal computer and the memory 112 may store a BIOS. The BIOS may store a set of instructions on a ROM chip which are run at the startup of the electronic device 100. The set of instructions controls the most basic operations of the device 100 and is capable of initializing the device hardware. The logic unit 140 may include components, devices or circuits required for performing the functions of the electronic device 100.

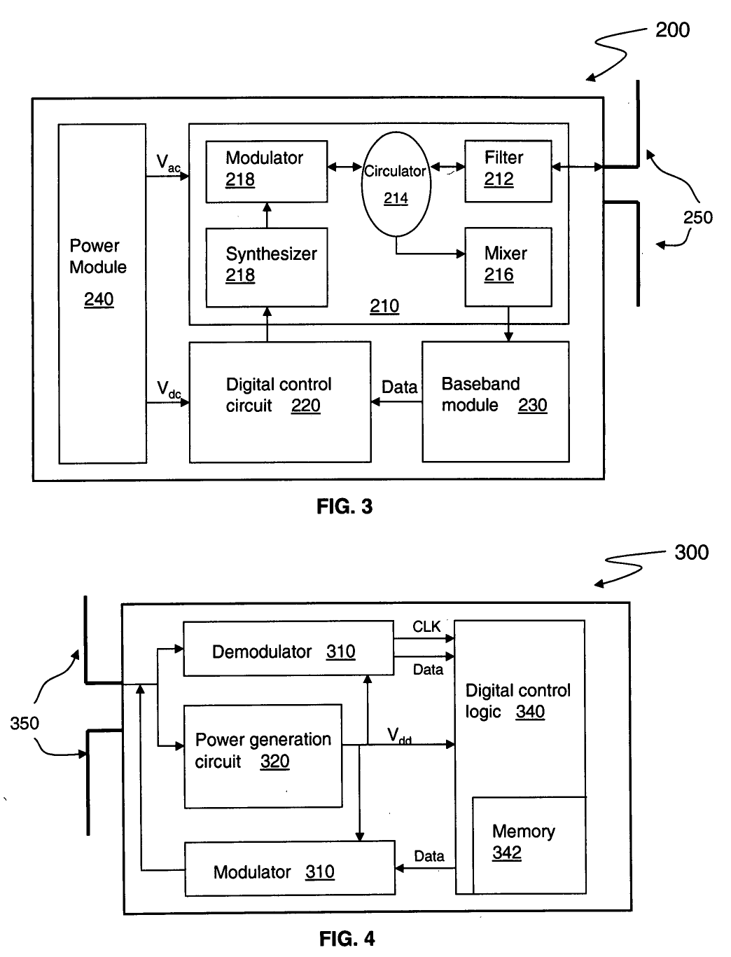

FIG. 3 illustrates an exemplary RFID interrogator in examples consistent with the present invention. Referring to FIG. 3, the RFID interrogator 200 may include a transmitter/receiver module 210, a digital control circuit 220, a baseband module 230, and a power module 240. The RFID interrogator 200 may be connected to antennas 250 either directly or through cables. The transmitter/receiver module 210 may further comprise a baseband filter 212, a circulator 214, a mixer 216, a modulator 218 and a synthesizer 219. With respect to the receiving operation of the RFID interrogator 200, the antennas 250 may detect an RF carrier at a frequency of approximately 125 KHz, 13.56 MHz, 915 MHz or 2450 MHz, and pass it through a bandpass filter 212 to a circulator 214. The circulator 214 may provide the signal received from an RFID tag through a mixer 216 to the baseband module 230 for demodulation. As a result, the baseband module 230 may provide a baseband data signal to the digital control circuit 220. With respect to the transmitting operation, the digital control circuit 220 may provide digital data signals to a synthesizer 219. The synthesizer 219 may prevent frequency pulling and provide a stable signal to modulator 218 for modulation onto the selected RF carrier. The modulated signal from the modulator 218 is then provided through the circulator 214 to the filter 212. The filter 212 may attenuate the modulated signal that has high offset frequencies relative to the carrier before transmitting the signal through the antennas 250 to a corresponding RFID tag. The power for the transmitter/receiver module 210, digital control circuit 220 and the baseband module 230 of the RFID interrogator 200 may come from the power module 240 such as a battery.

FIG. 4 illustrates an exemplary RFID tag in examples consistent with the present invention. The RFID tag 300 may include a demodulator 310, a power generation circuit 320, a modulator 330, and a digital control logic 340 with a memory 342. The RFID tag 300 may be connected to antennas 350 either directly or through cables. With respect to the receiving operation of the RFID tag 300, the antennas 350 may detect an RF carrier in a frequency of or approximately at 125 KHz, 13.56 MHz, 915 MHz or 2450 MHz, and pass it to a demodulator 310 for demodulation. The received RF carrier may be also provided to the power generation circuit 320 which may convert the RF power to DC power and provide the DC power supply for internal circuit of the RFID tag 300. The demodulated signal from the demodulator 310 may be provided to the digital control logic 340 for control of the RFID tag 300. With respect to the transmitting operation, the digital control logic 340 in response to the demodulated signal from the demodulator 310 may retrieve data stored in the memory 342 and provide it to the modulator 330. The modulator 330 may modulate the data from the memory 342 and then transmit the modulated data through antennas 350 to a corresponding RFID interrogator. The power for the demodulator 310, the modulator 330 and the digital control logic 340 of the RFID tag 300 may come from the power generation circuit 320. The RFID tag 300 may use at least two different frequencies for communication. The RFID tag 300 may be external to the electronic device 100, or alternatively, the RFID tag 300 may be integrated into the electronic 100.

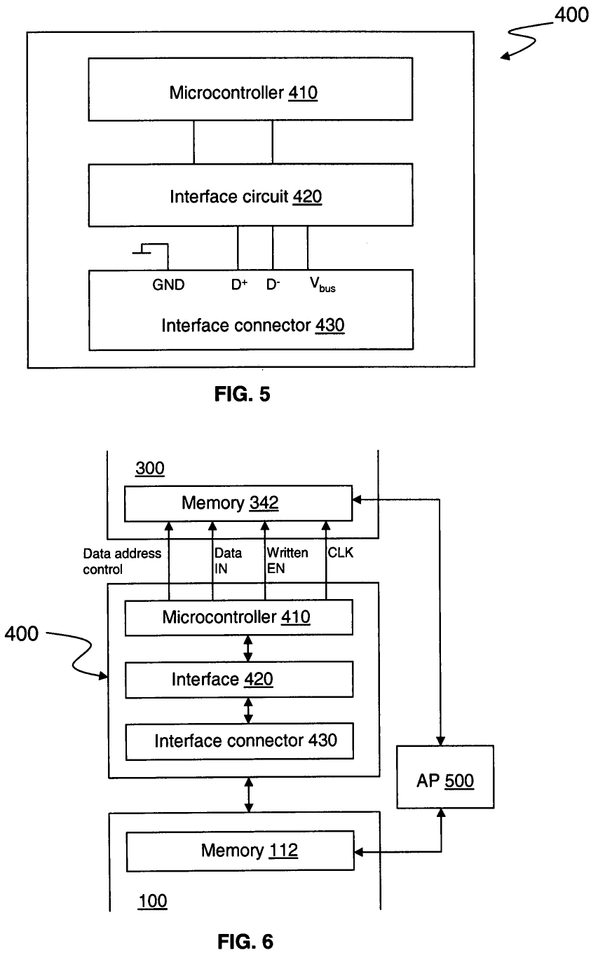

FIG. 5 is an exemplary interface in examples consistent with the present invention. The interface 400 may include a microcontroller 410, an interface circuit 420 and an interface connector 430. The microcontroller 410 is a processor, which may provide control of communication between the RFID tag 300 and the electronic device 100. The interface circuit 420 may convert data from the electronic device 100 into RFID data. For example, the interface circuit 420 may be an UART interface which may translate data between parallel and serial interfaces by converting bytes of data to and from asynchronous start-stop bit streams represented as binary electrical impulses. When the interface circuit 420 is an UART interface, the interface connector 430 is an RS232 or serial connector to connect to a connection port of an electronic device for transmission of data from the UART interface to the electronic device. In another example, the interface circuit 420 may be an USB interface. The USB interface 420 may provide an external peripheral interface for communication between an electronic device (e.g., a computer) and external peripherals over a cable using bit-serial transmission. When the interface circuit 420 is an USB interface, the interface connector 430 then may be an USB connector to connect to a USB port of an electronic device for transmission of data from the USB interface to the electronic device. In the case where the RFID tag 300 is integrated into the electronic device 100, the interface 400 may include a microcontroller 410 and an interface circuit 420. The interface 400 is connected to the electronic device 100 through pin connection or soldering points.

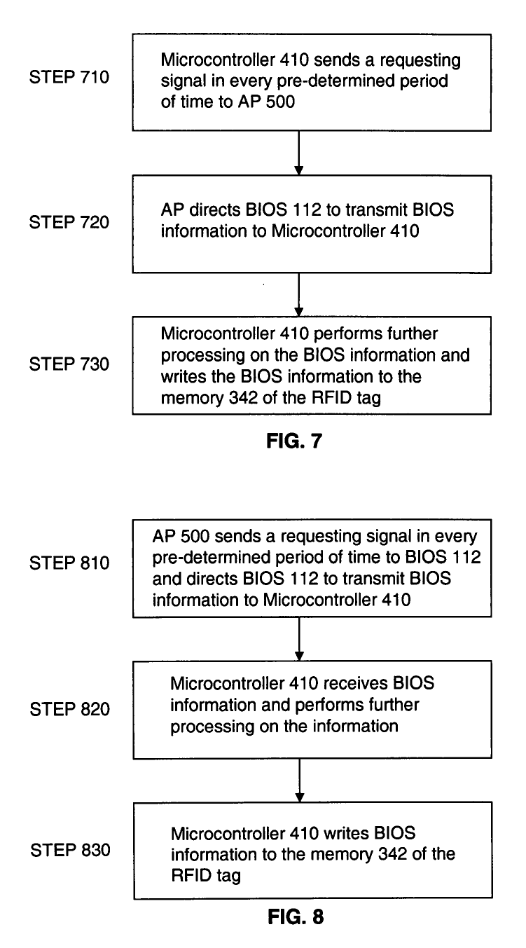

FIG. 6 illustrates portions of the communication system 10 with regard to communication between the RFID tag 300 and the electronic device 100. Referring to FIG. 6, the RFID tag 300 is connected to the electronic device 100 through the interface 400. FIG. 7 shows a flow chart of communication between the RFID tag 300 and the electronic device 100. In step 710, the microcontroller 410 of the interface 400 sends a requesting signal in every pre-determined period of time for requesting to read data in the memory 112 of the electronic device 100. An interface application module 500, which may be installed in the electronic device 100, may be provided to facilitate data transmission between the microcontroller 410 and the memory 112. The interface application module may also facilitate a user of the electronic device 100 to view the important or real-time data on a display of the electronic device 100. Upon detecting the requesting signal, the interface application module 500 directs data transmission from the memory 112 to the microcontroller 410 in step 720 through the interface connector 430 and the interface circuit 420. In one example, the interface application module 500 may direct a BIOS in the memory 112 to transmit the BIOS information to the microcontroller 410. In step 730, the microcontroller 410 may perform further processing on the data and may write the processed data to the memory 342 of the RFID tag 300 so that the RFID interrogator 200 may later retrieve updated information stored in the memory 342 of the RFID tag 300 by conventional wireless communication between RFID tags and RFID interrogators.

FIG. 8 shows another flow chart of communication between the RFID tag 300 and the electronic device 100. In step 810, the interface application module 500 sends a requesting signal in every pre-determined period of time to the memory 112 of the electronic device 100 and directs data transmission from the memory 112 to microcontroller 410 of the interface 400 through the interface connector 430 and the interface circuit 420. At the same time, the interface application module 500 sends a command to the microcontroller 410 to receive data from the memory 112. In step 820, upon receiving the command from the interface application module 500, the microcontroller 410 receives the data from the memory 112 and performs further processing on the data. In step 830, the microcontroller 410 may write the processed data to the memory 342 of the RFID tag 300 so that the RFID interrogator 200 may later retrieve updated information stored in the memory 342 of the RFID tag 300 by conventional wireless communication between RFID tags and RFID interrogators.

It will be appreciated by those skilled in the art that changes could be made to the examples described above without departing from the broad inventive concept thereof. It is understood, therefore, that this invention is not limited to the particular examples disclosed, but it is intended to cover modifications within the spirit and scope of the present invention as defined by the appended claims.

We claim:

1. A system, comprising:
an electronic device being configured to communicate with an external device;
a radio frequency identification (RFID) tag coupled to an antenna, the RFID tag being configured to communicate wirelessly through the antenna; and
an interface coupled to the electronic device and the RFID tag and being configured to communicate with the electronic device and the RFID tag,
wherein the electronic device and the RFID tag being configured to communicate with each other through the interface.

2. The system of claim 1, wherein the RFID tag is integrated into the electronic device.

3. The system of claim 1, wherein the RFID tag is coupled to the electronic device through external cables.

4. The system of claim 1, wherein the electronic device includes at least one of a personal digital assistant, cellular phone, refrigerator, air conditioning system, humidifier, network device, television, communication system, security systems, vehicle computer system, calculator, home appliance, and surveillance system.

5. The system of claim 1, wherein the RFID tag employs an external power supply.

6. The system of claim 1, wherein the interface comprises a microcontroller configured to control communications between the electronic device and the RFID tag.

7. The system of claim 1, wherein the interface comprises an interface circuit configured to convert information from the electronic device to RFID signals.

8. The system of claim 1, wherein the antenna is capable of detecting radio frequency signals at a frequency approximating at least one of 125 KHz, 13.56 MHz, 915 MHz and 2450 MHz.

9. The system of claim 1, wherein the RFID tag comprises a memory.

10. The system of claim 9, wherein the memory of the RFID tag is capable of storing information of the electronic device communicated through the interface.

11. The system of claim 1 further comprising an RFID interrogator which is capable of communicating wirelessly with the RFID tag through the antenna.

12. The system of claim 1, wherein the RFID interrogator supplies power to the RFID tag.

13. The system of claim 1, wherein the RFID tag is capable of using at least two frequencies for communicating wirelessly.

14. A method of operating a tracking system, comprising the steps of:
transmitting a requesting signal from an interface to request communication with an electronic device;
receiving data from the electronic device to the interface;
converting the data from the electronic device into radio frequency identification (RFID) signals; and
transmitting the RFID signals from the interface to an RFID tag.

15. The method of claim 16, wherein the requesting signal is transmitted from an interface application module periodically.

16. An interface for providing communications between an electronic device and an RFID tag, comprising:
a microcontroller configured to control communications between the electronic device and an RFID tag;
a memory device coupled with the microcontroller, the memory device being configured to store data; and
an interface circuit coupled with the microcontroller and the memory device, the interface circuit being configured to convert data from the electronic device into a RFID signal.
